(19) United States
(12) Patent Application Publication
(10) Pub. No.: US 2022/0003027 A1
(43) Pub. Date: Jan. 6, 2022

(54) QUICK-DEPLOY EMERGENCY DOOR SECURING DEVICE

(71) Applicant: Tri Cell USA LLC, Rowland Heights, CA (US)

(72) Inventor: Charles B. Joh, Rowland Heights, CA (US)

(21) Appl. No.: 17/365,487

(22) Filed: Jul. 1, 2021

Related U.S. Application Data
(60) Provisional application No. 63/046,844, filed on Jul. 1, 2020.

(51) Int. Cl. E05C 19/18

(52) U.S. Cl. CPC E05C 19/188

(57) ABSTRACT

Provided is a quick-deploy emergency door securing device for a door having a folding-arm door closing device. It includes an elongated strap having a length and first and second ends. The first end is fixedly securable to one of two arms of the door closing device. The strap may be wrapped around both arms and fastened in place to itself to prevent opening of a door by preventing separation of the door closing device arms.

### RELATED APPLICATIONS

This application claims priority to U.S. Provisional Patent Application No. 63/043,844, filed Jul. 1, 2020, and incorporates the same herein by reference.

### TECHNICAL FIELD

This invention relates to a device for securing a door in a closed position. More particularly, it relates to a device that can be retrofit to a door with a door-closing device that includes hinged arms.

### BACKGROUND

Many devices have been proposed to provide a quickly deployable lock for doors in public buildings, such as schools, when the need suddenly arises for a “lock down” condition to protect the occupants from a known or perceived violent threat. Many such devices require permanent installation or modification of the door and/or door frame. Others require a separate apparatus to be stored (presumably) near, but separate from, the door. Devices used on doors that open inwardly (pull) often need to be quite different from those used on doors that open outwardly (push).

It is common for doors in public buildings to include an automatic door closer, so that the door will default to a closed position for fire safety. A common type of these closing devices includes a linkage with a pair of pivoting arms, one end attached to the door, another end attached to the door frame, and with a pivot joint in the middle joining the arms. These arms extend when the door is opened and fold to a near-parallel position when closed. These arms are almost always on the inside of an exterior door and inside of a room opening to a hallway, regardless of whether the door opens by pushing or pulling. Typically, these pivoting arms are in a near parallel position when the door is closed. In some installations, the folded arms project into the room; in others they lie somewhat parallel to the door.

### SUMMARY OF THE INVENTION

The present invention provides a quick-deploy emergency door securing device for a door having a folding-arm door closing device. It includes an elongated strap having a length and first and second ends. The first end is fixedly securable to one of two arms of the door closing device. The strap may be wrapped around both arms and fastened in place to itself to prevent opening of a door by preventing separation of the door closing device arms.

The device can be installed to lash together the near-parallel arms of a door closer while the door is closed to prevent the door from being opened. The strap and be webbing, pre-attached to one of the pivoting arms and held in a folded, ready-to-deploy position without interfering with normal operation of the door. Pulling a free end of the strap deploys it so it then can be wrapped around the pair of arms, distal from the pivot, and secured in place to prevent the door from opening.

The strap may be secured, for example, with hook-and-loop faster material extending along substantially the full length of opposite sides of the strap. If desired, material that enhances grip, such as an elastomer, may be applied to the first few inches of the strap that will directly contact the arms when wrapped/wound. The webbing strap is extremely strong and the shear strength of hook-and-loop fastener material cannot be overcome by opening the door (which requires spreading and extending the pivot-hinged closer arms). Yet, the device can be quickly removed when the treat has passed or rescue personnel arrives.

Other aspects, features, benefits, and advantages of the present invention will become apparent to a person of skill in the art from the detailed description of various embodiments with reference to the accompanying drawing figures, all of which comprise part of the disclosure.

### BRIEF DESCRIPTION OF THE DRAWINGS

Like reference numerals are used to indicate like parts throughout the various drawing figures, wherein:

FIG. 1 is a pictorial view of a device according to one embodiment of the invention;

FIG. 1A is a similar view with an alternate attachment means;

FIG. 2 is a pictorial view of the device attached at a first end to one arm of a door-closing device, which can be a deployed position;

FIG. 3 is a pictorial view of the device in a ready-to-deploy condition;

FIG. 4 is a pictorial view of the device partially wrapped around the pivoting arms of a door-closing device; and

FIG. 5 is a pictorial view of the device in a secured position.

### DETAILED DESCRIPTION

With reference to the drawing figures, this section describes particular embodiments and their detailed construction and operation. Throughout the specification, reference to “one embodiment,” “an embodiment,” or “some embodiments” means that a particular described feature, structure, or characteristic may be included in at least one embodiment. Thus, appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments.

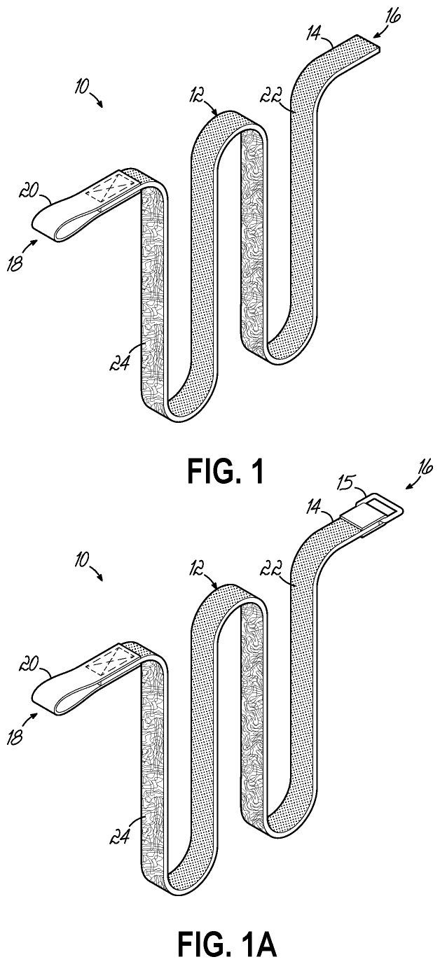

Referring first to FIG. 1, therein is shown a device 10 according to one embodiment of the present invention. The device 10, includes an elongated strap 12 which may be made of a high-strength webbing material, for example one-inch in width. At a first end of the strap 12 is an attachment means 14 which is used to secure the first end 16 of the strap 12 to one of the pivot-hinged arms of a door-closer device. The attachment means 14 may comprise, for example, mating hook-and-loop material surfaces that allow the first end 16 to be wrapped and fastened to a door-closer arm. FIG. 1A shows an alternate attachment means in the form of a ring 15 secured to the first end 16 such as by sewing. The first end 14 is secured to the arm buy looping the strap 12 around the arm and passing a second end 18 and remainder of the strap 12 through the ring 15. Other means of attachment, whether a snap or more permanent fastening, like a rivet, may be used as well. The second end 18 of the strap 12 may include a handle portion 20 to facilitate gripping with a hand. The handle 20 may be an extended end portion of the strap 12, a folded portion to add stiffness, or a loop. The handle 20 may be a contrasting and/or bright color to allow easy recognition. The strap 12 may be from 12 inches to 36 inches in length, for example.

According to the illustrated embodiment, substantially the entire length of one side of the strap 12 may be covered with hook-type fastener material 22 and the opposite side 24 covered with loop-type fastener material. If desired, the fastener material can be attached, such as by sewing or with an adhesive, in segments to facilitate folding of the strap 12. Alternatively, the strap may be made of a material that has mating hook-and-loop materials integrated into opposite sides thereof.

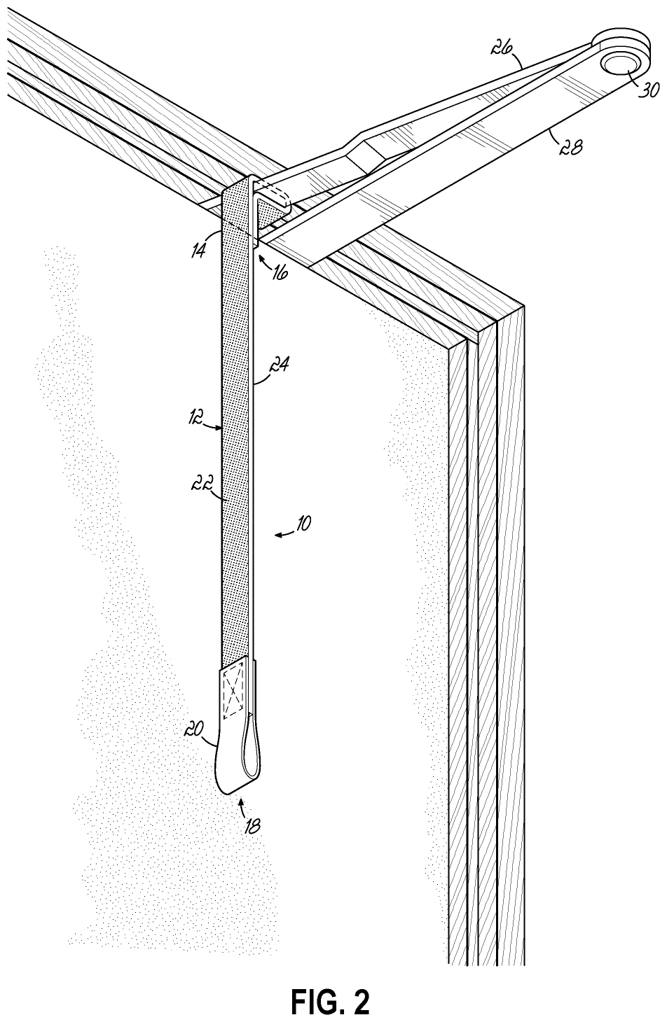

Referring now to FIG. 2, therein is shown the first end 16 of the strap 12 secured to one of the closer arms 26, 28 distal from the pivot connection 30 (not shown in FIG. 2).

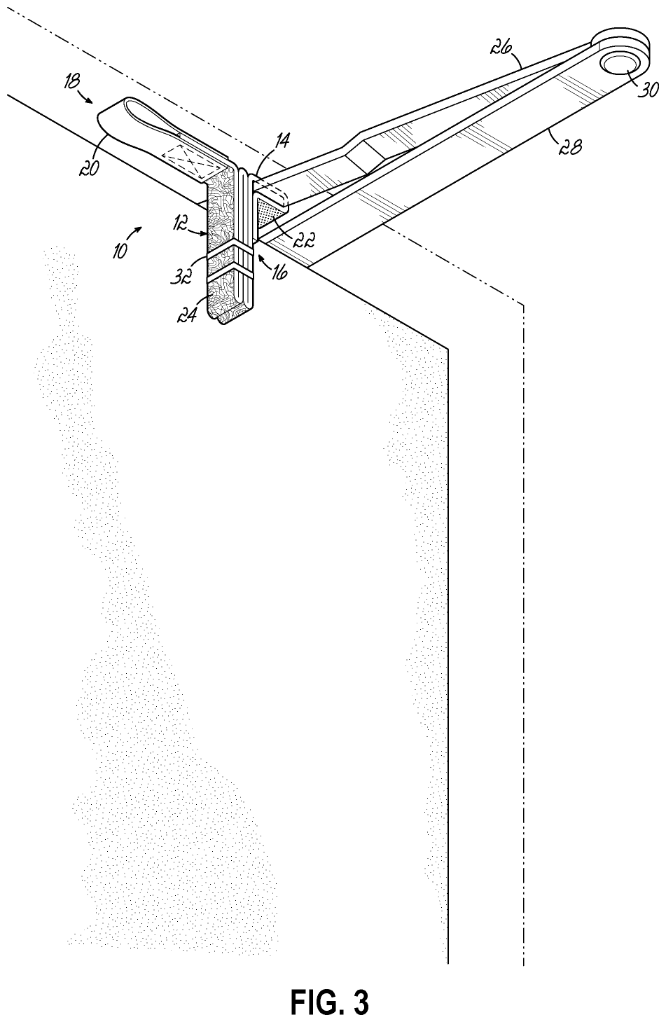

Referring now to FIG. 3, therein is shown how the strap 12 of the device 10 may be folded while the first end 16 is attached to a closer arm 26 and ready to be deployed for use. The strap 12 may be held in the folded condition by an elastic or breakable band 32. Simply pulling downward on the handle 20 will cause the band 32 to dislocate or break, extending the strap 12 to its full length. By being folded, it extends rapidly and does not require unrolling or other preparation for use.

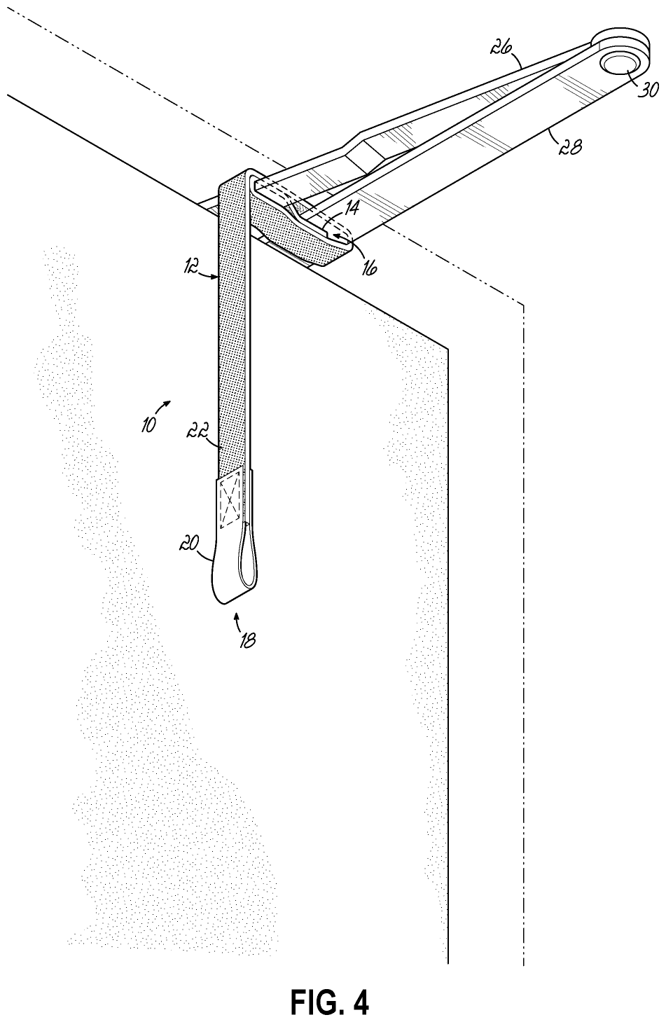

Referring now to FIG. 4, in order to secure the door against opening, the closer arms 26, 28 may be bound together by wrapping the strap 12 around the arms 26, 28 multiple times. By having mating hook-and loop-type fastener materials 22, 24 on opposite sides of the strap 12, the overlapping layers of the wound strap 12 adhere to each other with extraordinary tensile and sheer strength, and with virtually no stretch.

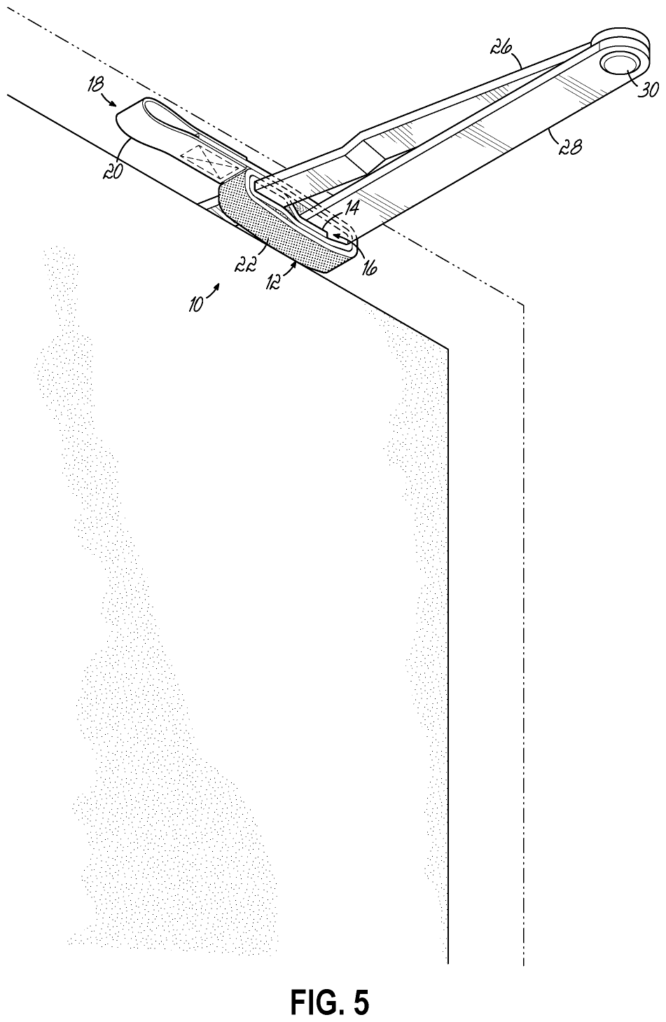

Referring now to FIG. 5, the device 10 is shown in a fully operational condition in which the closer arms 26, 28 are bound together distal to the pivot joint 30. By preventing the closer arms 26, 28 from moving apart, the door is secured against opening from the opposite side. Securing the strap 12 on the arms 26, 28 distal from the pivot joint 30, the leverage of moving the door in minimized and allows the door to be opened only a negligible amount.

While one or more embodiments of the present invention have been described in detail, it should be apparent that modifications and variations thereto are possible, all of which fall within the true spirit and scope of the invention. Therefore, the foregoing is intended only to be illustrative of the principles of the invention. Further, since numerous modifications and changes will readily occur to those skilled in the art, it is not intended to limit the invention to the exact construction and operation shown and described. Accordingly, all suitable modifications and equivalents may be included and considered to fall within the scope of the invention, defined by the following claim or claims.

What is claimed is:

1. A quick-deploy emergency door securing device for a door having a folding-arm door closing device, comprising:
a strap having a length and first and second ends, the first end fixedly securable to one of two arms of a door closing device,
wherein the strap may be wrapped around both arms and fastened in place to itself to prevent opening of a door by preventing separation of the door closing device arms.

2. The device of claim 1, wherein the first end is securable to the arm with hook and loop fastener material.

3. The device of claim 1, wherein the first end is securable to the arm by making a loop of the strap through a ring attached to the first end.

4. The device of claim 1, wherein the strap is fastenable in place to itself with hook and loop fastening material.

5. The device of claim 4, wherein the hook and loop fastening material covers at least a majority of the strap's length.

6. The device of claim 1, wherein the device further includes a loop handle the second end.

7. The device of claim 1, wherein the length of strap can be folded into a stack and releasably secure in folded condition adjacent first end for ready deployment.
